(19) United States
(12) Patent Application Publication
(10) Pub. No.: US 2015/0146172 A1
(43) Pub. Date: May 28, 2015

(54) CURVED PROJECTOR SCREEN

(71) Applicants: CENTRE SCIENTIFIQUE ET TECHNIQUE DU BATIMENT, Champs Sur Marne (FR); IMMERSION, Bordeaux Bastide (FR)

(72) Inventors: Julien Maillard, Saint Martin D'Heres (FR); Gabriel Soubies, Portets (FR)

(21) Appl. No.: 14/403,946

(22) PCT Filed: Jul. 3, 2013
(86) PCT No.: PCT/FR2013/051578

§ 371 Date: Nov. 25, 2014

(30) Foreign Application Priority Data
May 25, 2012 (FR) 1254816

(51) Int. Cl. G03B 21/606; G03B 31/00; G02B 27/22; G03B 21/56

(52) U.S. Cl. CPC G03B 21/606; G03B 21/565; G03B 31/00; G02B 27/2221
USPC 353/10; 359/445; 359/444; 353/15

(57) ABSTRACT

The invention relates to a projector screen having a projection surface essentially forming a spheric section, comprising a rigid structure (1) that is preferably male of a metal, and a membrane (2) that is preferably made of a textile, the membrane being supported by said rigid structure (1), characterised in that the membrane (2) envelops the rigid structure (1) and in that a means (3) for generating a vacuum is provided in order to keep the membrane (2) pressing against the rigid structure (1). Application to screening rooms.

### TECHNICAL FIELD OF THE INVENTION

The invention relates to the field of projection screens, in particular for auditoriums, cinemas, etc. In this field, projections more and more concern videos and sound systems involving three-dimensional (3D) perception that is as realistic as possible.

Many solutions are proposed for accentuating the 3D perception by the spectator.

### PRIOR ART

Thus, through the document U.S. Pat. No. 7,106,411, equipment suited to auditoriums comprising at least one curved screen and an alternative sound system is known. This document discloses a screen consisting of a perforated and flexible projection surface material such as vinyl; and tensioned by a frame situated behind the projection surface.

This solution is however not satisfactory since, in this configuration, the screen is not sufficiently held against the frame, so that the shape of the screen may be modified, for example by air currents. Even with fixings between the frame and the projection surface, the surface of the screen is not sufficiently uniform.

Through the document FR 2 567 035, a moving structure is known that comprises a screen in the form of a dome comprising a lattice chassis and a solid observation face. A membrane is stuck to the observation face by the creation of a vacuum, and a hardenable coating material is sprayed onto the membrane in order to stiffen it.

In this type of screen, the optical and acoustic properties of the membrane are altered by the hardenable material and/or the solid observation face.

### DISCLOSURE OF THE INVENTION

The invention aims to remedy the drawbacks of the prior art and in particular to propose a system affording better 3D perception for the spectators from both the audio and the video point of view.

To do this, a projection screen is proposed having a projection surface forming essentially a section of a sphere, comprising a rigid structure, preferably metallic, and a membrane preferably made from textile material supported by said rigid structure. “Projection surface forming essentially a section of a sphere” means a surface that has roughly the form of a section of a sphere or cylinder. In general terms, a curved screen is also spoken of to designate the type of screen according to the invention.

According to a first aspect of the invention, the membrane envelops the rigid structure and a depressurisation means is provided for holding the membrane under negative pressure against the rigid structure.

Thus the general structure and the optical properties of the membrane, in particular for reflecting the projected images, can be used without adding any polymer to stiffen it. In particular, the use of a rigid structure in the form of a frame and a microperforated membrane also makes it possible to keep the advantageous acoustic properties, in particular a trans-sound aspect of the curved screen.

Preferably, the rigid structure comprises aluminium. Thus the screen according to the invention comprises a rigid lightweight frame.

According to a variant, a closure means is provided for hermetically closing the membrane held under negative pressure against the rigid structure.

According to a preferred embodiment, the membrane is microperforated with a porosity making the screen trans-sound and compatible with the negative-pressure means. For example, the suction intensity is sufficiently great to compensate for the losses related to the microperforation.

Preferably, at least one loudspeaker is provided inside the screen.

According to a preferred variant, a plurality of loudspeakers are provided inside the screen, positioned substantially in accordance with a section of a sphere.

According to an advantageous aspect, the membrane is connected to the negative-pressure means by means of a suction duct.

The invention also relates to a projection system comprising a projection screen as described above and a plurality of projectors, in frontal projection, and/or a plurality of loudspeakers positioned in one or more hemispheres and centred on an external point situated in the concavity of the screen. This point corresponds in particular to the position of one or more spectators.

Advantageously, the projection system of the invention comprises at least one loudspeaker positioned outside the screen, in the convexity thereof.

Another subject matter of the invention concerns a film theatre comprising a screening room as described above.

### BRIEF DESCRIPTION OF THE FIGURES

Other features, details and advantages of the invention will emerge form a reading of the following description, with reference to the accompanying figures, which illustrate:

FIG. 1, a view in the space of the rigid structure and positions of the various loudspeakers of the projection system according to the invention;

FIG. 2, a side view of an auditorium comprising the projection system according to the invention;

FIG. 3, a plan view of an auditorium comprising FIG. 2.

For greater clarity, identical or similar elements are marked by identical reference signs in all the figures.

### DETAILED DESCRIPTION OF AN EMBODIMENT

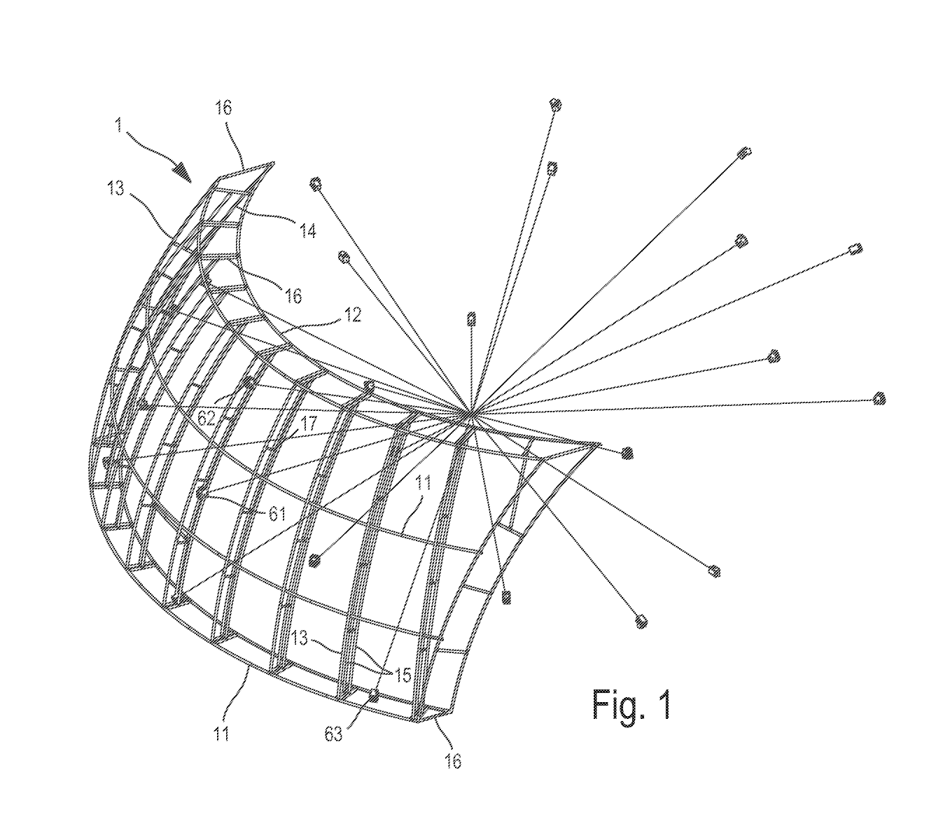

With reference to FIG. 1, the projection screen according to a preferred variant of the invention comprises a rigid structure 1 of the aluminium frame type. The frame 1 is roughly in the form of a section of a sphere with preferably a thickness 0.5 m to 1 m. The height of the frame is compatible with its use, in particular in an auditorium. Preferably, the height is between 3 m and 5 m.

The frame 1 is formed by a plurality of bars connected together by known means. For example, these bars are welded together or screwed. A first set of bars 11 forms horizontal external arcs and a second set of bars 12 forms internal horizontal arcs. In the same way, external vertical arcs 13 and internal vertical arcs 14 are also provided. Preferably, the internal vertical arcs 14 are solely provided at the right and left ends of the screen, the rest of the screen having intermediate vertical arcs 15 at an intermediate position between the external vertical arcs 13 and the internal vertical arcs 14. Struts 16 and 17 are also provided in order to fix together the various arcs. The struts 16 are situated substantially on the external periphery of the framework structure, and the struts 17 are situated inside the framework structure.

The frame 1 will next be covered with a fabric 2, preferably microperforated so that the screen is trans-sound, that is to say transparent to sound waves.

Thus it is possible to provide a plurality of loudspeakers 61 to 64 inside the screen. As can be seen in FIG. 1, such loudspeakers are for example fixed to struts 17 or to the intermediate arcs of the rigid structure 1. The loudspeakers 61 to 64 are situated respectively substantially at the middle, at the top, at the base and at the rear of the rigid structure 1.

As can be seen in FIG. 1, all the loudspeakers in a film theatre comprising the screen according to the invention are positioned according to hemispheres with given radii, centred on the spectator or spectators, placed in a space facing the concavity of the screen.

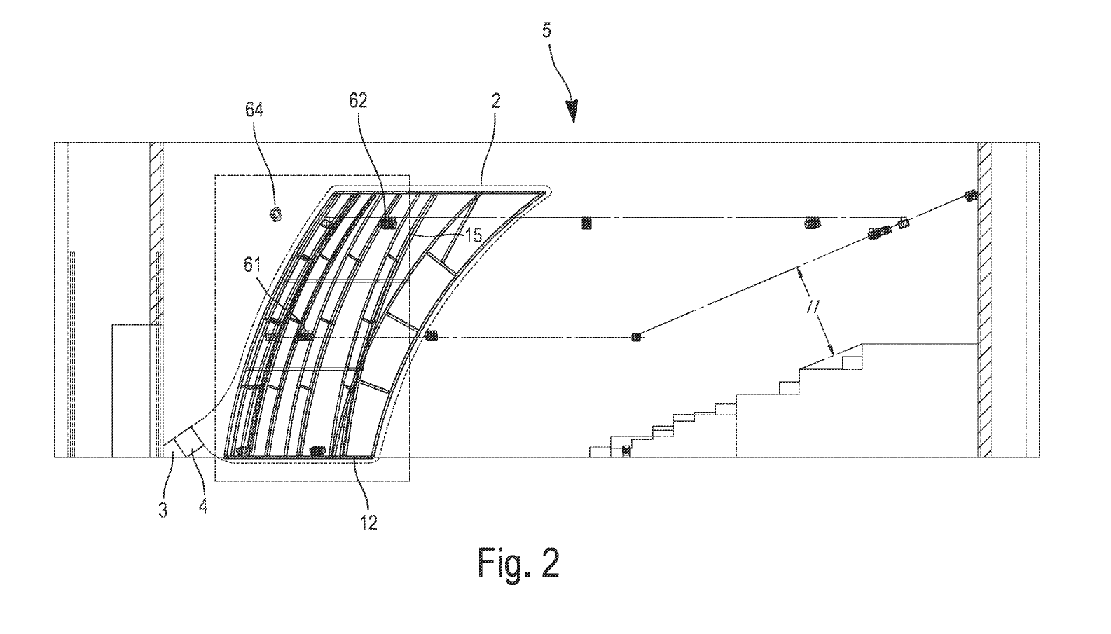

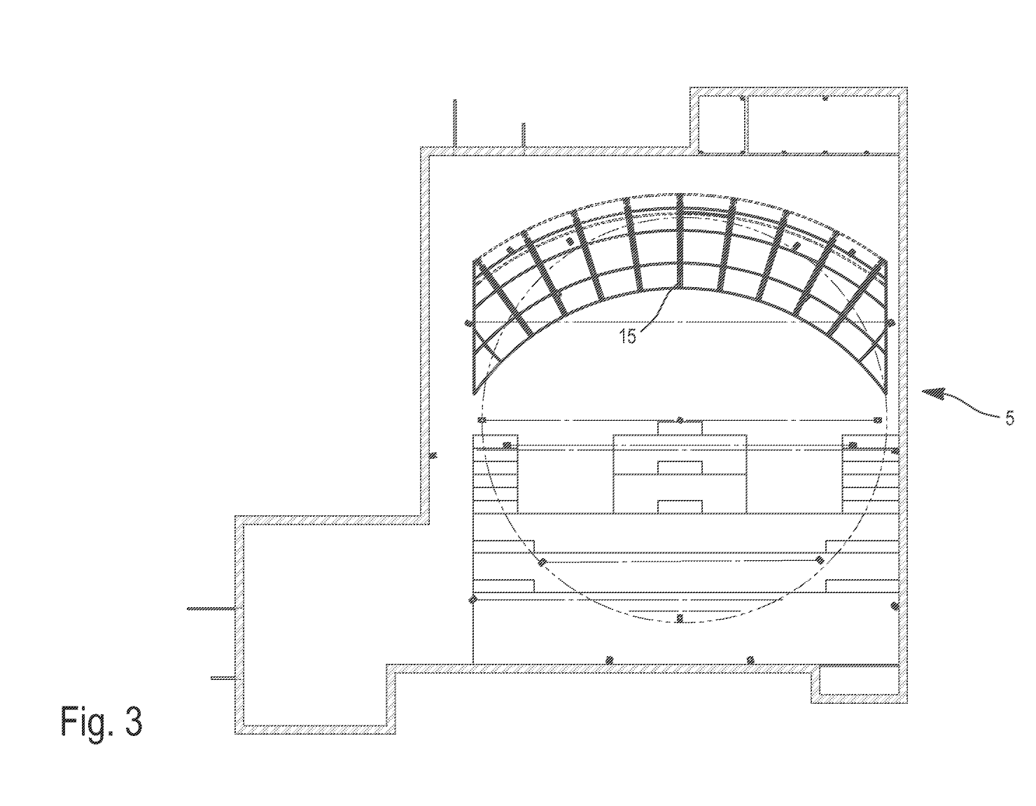

As can be seen in FIGS. 2 and 3, the frame 1 is provided in a screening room 5 such as a cinema auditorium or a theatre. The microperforated fabric 2 is disposed around the frame 1 and tensioned thereon. A negative pressure is then created by a means such as a suction fan 3 connected to a suction duct 4 in order to hold the membrane 2 against the frame 1. In particular, the lateral edges of the concave face of the membrane are held against the vertical arcs 14. The rest of the concave face of the membrane 2 is held against the intermediate arcs 15.

The membrane 2 is a micro-perforated membrane suitable for uses in projection. For example, a Yards White Oxford fabric marketed by the company Ntension can be used. The characteristics of the preferred fabric are detailed in tables 1 and 2 below:

TABLE 1
Data sheet for the preferred fabric:

| | |
|---|---|
| Name of product: | Tissue pack |
| Type of article: | 400 × 400 denier nylon |
| Coating: | 0.63 oz of urethane (17.86 g) |
| Finish: | Colours, DWR |
| Weave: | Uni |

TABLE 2
Characteristics and typical values:
Construction of the fabric

| | |
|---|---|
| Warp: | 60 |
| Weft: | 38 |
| Total weight (oz/sq): | 5.7 oz (approx. 193.26 g/m²) |
| Added coating (oz/sq): | 0.63 oz (approx. 21.36 g/m²) |

Resistance to rupture “ASTM D 5034-90 (1″ Grab)”

| | |
|---|---|
| Warp: | 530.6 lbs (approx. 231 kg) |
| Weft: | 379.5 lbs (approx. 165 kg) |

Resistance to tearing (initiated tearing) “ASTM D 2261-91”

| | |
|---|---|
| Warp | 32.6 lbs (approx. 14.2 kg) |
| Weft | 26.1 lbs (approx. 11.4 kg) |

Taber abrasion metre

| | |
|---|---|
| ASTM D 3884 (After 1000 cycles) | Tested samples slightly |
| | damaged |

The screen according to the invention is preferably used in front projection with a plurality of projectors. By way of illustration, the screen according to the invention is used with eight projectors. Naturally a different number of projectors may be envisaged. A system according to the invention with one projector can be envisaged but is less preferred.

Numerous combinations can be envisaged without departing from the scope of the invention; a person skilled in the art will choose one or other according to the economic, ergonomic, dimensional or other constraints that he will have to comply with.

1. Projection screen having a projection surface forming a section of a sphere, comprising a rigid structure, and a membrane supported by said rigid structure, the membrane enveloping the rigid structure, and a depressurisation means that holds the membrane under negative pressure against the rigid structure, wherein the membrane is microperforated with a porosity making the screen trans-sound and compatible with the negative-pressure means.

2. Projection screen according to claim 1, wherein the rigid structure comprises aluminium.

3. Projection screen according to claim 1, wherein a closure means is provided for hermetically closing the membrane held under negative pressure against the rigid structure.

4. Projection screen according to claim 1, wherein at least one loudspeaker is provide inside the screen.

5. Projection screen according to claim 1, wherein a plurality of loudspeakers are provided inside the screen, positioned substantially according to a section of a sphere.

6. Projection screen according to claim 1, wherein the membrane is connected to the negative-pressure means by means of a suction duct.

7. Projection system comprising a projection screen according to claim 1 and at least one of a plurality of projectors, in front projection, or a plurality of loudspeakers positioned in accordance with one or more hemispheres centred on an external point situated in the concavity of the screen.

8. Projection system according to claim 7, comprising at least one loudspeaker positioned outside the screen, in the convexity thereof

9. Screening room comprising a projection screen according to claim 1.

10. Screening room comprising a projection system according to claim 7.

11. Projection system of claim 1, wherein the rigid structure is made of a metallic material.

12. Projection system of claim 1, wherein the membrane is made of a textile material.
